(19) United States
(12) Patent Application Publication
(10) Pub. No.: US 2008/0209474 A1
(43) Pub. Date: Aug. 28, 2008

(54) Method And Apparatus For Managing Tv Channel Lists

(75) Inventors: Ilija Pjanovic, Eindhoven (NL); Alfred Orsel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/720,101

(22) PCT Filed: Nov. 22, 2005
(86) PCT No.: PCT/IB05/53862

§ 371 Date: May 24, 2007

Related U.S. Application Data
(60) Provisional application No. 60/630,690, filed on Nov. 24, 2004.

(51) Int. Cl. G06F 3/00

(52) U.S. Cl. 725/46

(57) ABSTRACT

Disclosed are a system and method for generating a favorite list from a plurality of broadcast/Internet contents according to the preferences of the user. A plurality of incoming television and Internet contents is examined to identify a particular program liked by a viewer according to a past viewing history, then a general list containing at least one television content and at least one Internet content and a favorite list containing a list of program contents liked by the viewer based on the past viewing history are generated. The favorite list is saved in a memory so that it is not deleted during an automatic channel installation.

The present invention relates to a system and method in which a plurality of broadcast contents is presented according to the user's preferences.

The modern world with huge amounts of multimedia content and varied delivery options gives us a tremendous variety and range of options and choices. Cable and satellite television delivers hundreds of different television channels, each carrying a different program. As more enriching information is available to consumers, viewers often spend a lot of time “channel surfing,” trying to find something he or she is interested in watching. Attempts are made to record programs that may be of interest to the viewers, which often results in a hard disk full of unwanted programs. As a result, the viewer must remove programs before more shows can be recorded. For example, in today's TV sets, it is possible to perform an “automatic channel installation” of available programs. However, the previous program list is deleted whenever the automatic installation occurs.

Therefore, there is a need to customize television programming and the information superhighway of the Internet so that viewers can find programs of interest without spending a great amount of time finding and searching different programs.

One aspect of the invention is to allow viewers to browse favorite programs in a more efficient manner.

Another aspect of the invention is to provide a means so that the materials of interest are selectively delivered to the viewers automatically.

Another aspect of the invention is to provide a method of providing a channel list from a plurality of sources by identifying a particular program or channel liked by a viewer according to a past viewing history and saving a favorite list containing a list of program contents or channels liked by the viewer based on the past viewing history so that the favorite list is not deleted during an automatic channel installation. The favorite list may be updated interactively by a user by adding or deleting a program.

Yet another aspect of the invention is to provide an apparatus for providing a channel list from a plurality of sources. The apparatus includes a playback unit for receiving at least one television content and at least one Internet content and for generating a favorite list containing a list of program contents or channels liked by a viewer based on a past viewing history, and a display unit for displaying the general list and favorite list so that the viewer can interactively make a selection. The favorite list is saved in a memory to avoid deletion during an automatic installation.

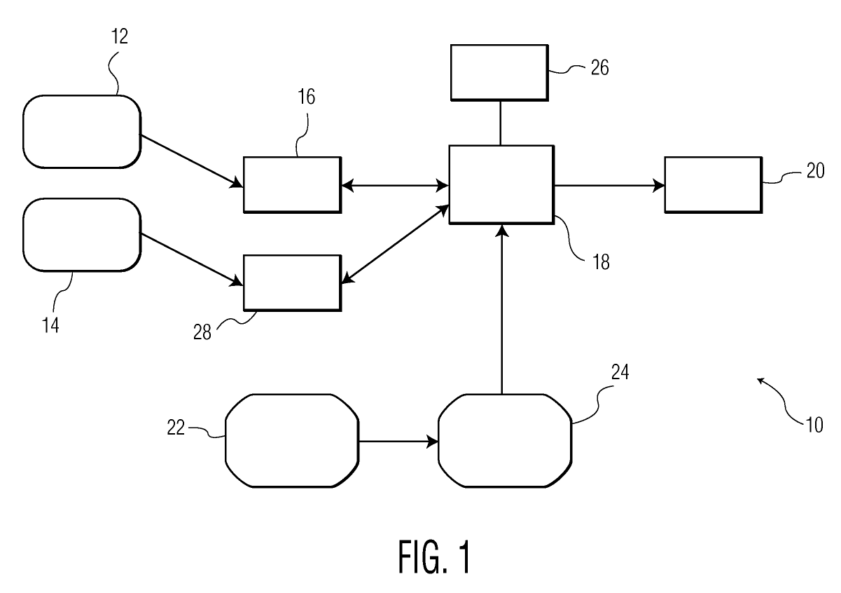

FIG. 1 illustrates a simplified block diagram of the system according to the present invention;

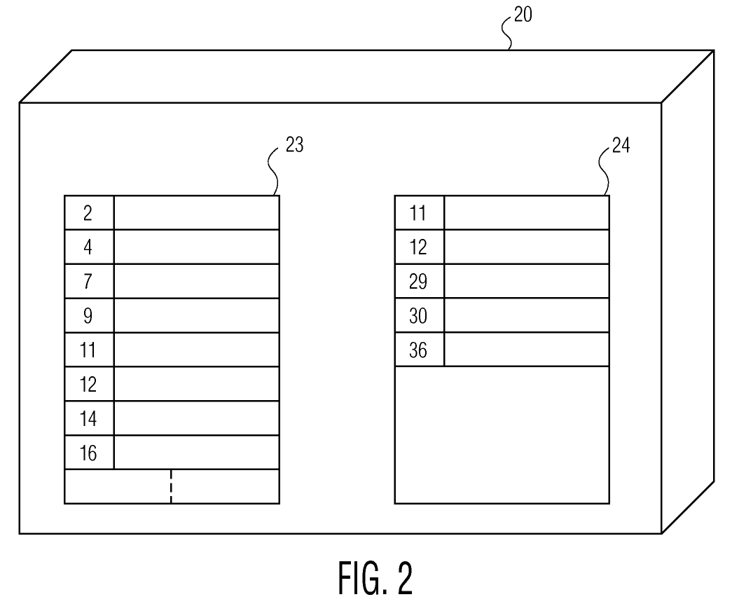

FIG. 2 is a diagram showing the integration of the program contents according to the present invention;

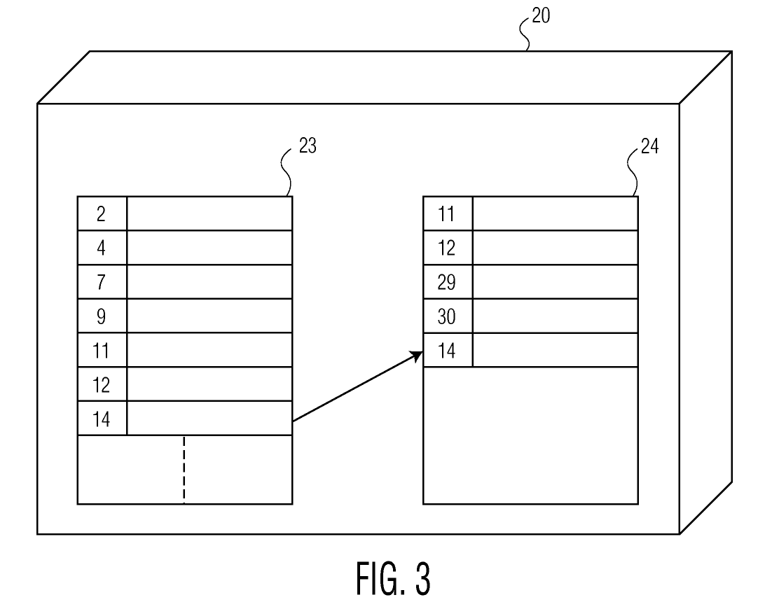

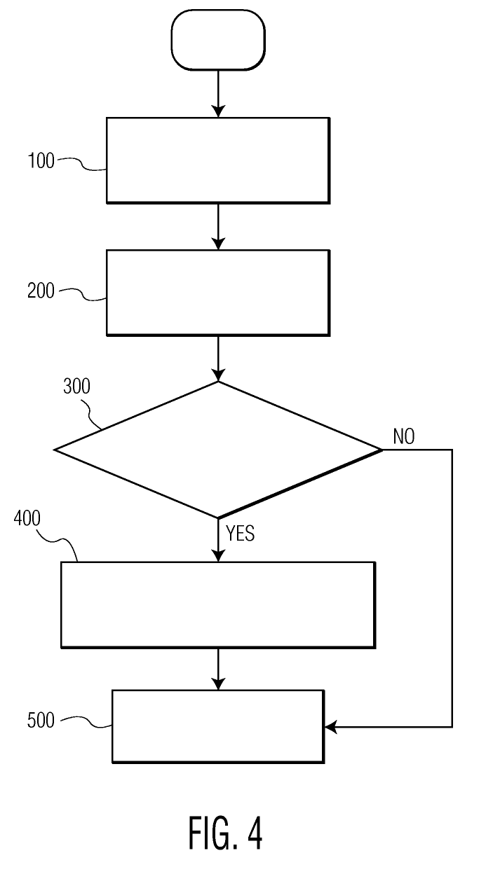

FIG. 3 is a diagram showing the user interface screen according to the present invention; and, FIG. 4 is a flow diagram of operation steps of the present invention.

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments that depart from these specific details. Moreover, for the purpose of clarity, detailed descriptions of well-known devices, circuits, and methods are omitted so as not to obscure the description of the present invention with unnecessary detail.

Referring to FIG. 1, an embodiment of the present invention is a system 10 for customizing content (audio, video, and data) from television and other content sources (e.g., the Internet) according to their objective preferences. The system 10 would comprise a central processing unit (CPU) with one or more memory devices. As shown, the system 10 is configured to receive audio/video programming and data signals from the conventional television (TV) broadcast 12 and the Internet 14, respectively. Here, the audio/video programming along with the data signals can be delivered in analog, digital or digitally compressed formats via any transmission means, including satellite, cable, wire, television broadcast or sent via the Web. The Internet connection can be via a high-speed line, RF, conventional modem or by way of a two-way cable carrying the video programming. Further, it should be noted that the present system is capable of being connected to other possible networks, such as a direct private network and a wireless network. A tuner 16 is provided to receive the TV broadcast, and a decoder 28 is provided to receive the Internet contents. The decoder 28 may be an MPEG decoder that complies with all MPEG standards, i.e., MPEG-1, MPEG-2, MPEG-4, and MPEG-7. The retrieved broadcast and Web contents are briefly stored in a memory 26, which is coupled to a playback engine 18, for a subsequent replay via a display 20. A viewing preference logic 22 is on a timer and updates the special favorite list 24. For example, it may tack which channel numbers were watched at 10 pm.

Referring to FIG. 2, the playback engine 18 oversees the overall operations of the system 10, including a view mode, record mode, play mode, and other modes that are common in the conventional set-top box. In particular, the playback engine 18 manages two sets of program lists. A general list 23 includes a list of entire program channels received by the system 10, so that the user can go through all available programs to pick a desired channel or program. A special favorite list 24 includes a set of favorite channels preferred by the user that are selected based on the viewer's past viewing habits. The viewer has an option of looking at the favorite list 24 and adding or removing a program or channel. The scheduling information for the TV contents is provided by a well-known electronic program guide (EPG) protocol. An EPG is a standard application designed to aid the viewer in the navigation of and selection from broadcast material available in a digital TV environment. Basically, an EPG is an interactive, on-screen display feature that displays information analogous to television listings found in local newspapers or TV guides or EPG services like a tribune. The EPG provides information about each program and includes programming characteristics, such as the channel number, program title, start time, end time, elapsed time, time remaining, rating (if available), topic, theme, and a brief description of the program's content.

Using the EPG features, the playback engine 18 maintains a list of all programs received thereon in the general list 23. At the same time, the viewing preference logic 22 can maintain a list of programs, channels, and Internet addresses that the viewer frequently watches, and then apply heuristics to find the favorite programs or channels and store them in the favorite list 24. Obtaining a list of favorite TV channels, TV programs, Internet addresses based on the viewing history can be performed in a variety of ways. See, for example, PCT WO 01/45408 (Gutta) that is assigned to the same assignee, and the content of which is hereby incorporated by a simple reference. Gutta uses inductive principles to identify a set of recommended programs that may be of interest to a particular viewer, based on the past viewing history of a user. To this end, the system monitors a user's viewing history and analyzes the shows that are actually watched by a user (positive examples) and the shows that are not watched by the user (negative examples). For each positive and negative program example (i.e., programs watched and not watched), a number of program attributes are classified in the user profile, such as the time, date, duration, channel, rating, title, and genre of a given program. Then, these various attributes are used to generate a decision tree. Thus, based on the user's viewing pattern, a database reflecting the user's likes or dislikes of various program contents can be obtained. Alternatively, another way of making the inference is by using a Bayesian classifier. This statistical-based machine-learning technique looks at different variables, such as teams and athletes, and waits to see which ones stand out above a noise threshold. In this case the classifier can give slightly higher weights to local teams and athletes.

Thereafter, the playback engine module 18 presents the favorite list to the display unit 20 so that the user can select the desired program or channel. As such, the audio/video that is broadcast over a conventional broadcast or cable transmission means as well the related Web pages retrieved via the Internet system are received and organized according to the viewing preferences of the user. In an alternate embodiment, the playback engine 18 can store the programs of interest provided in the favorite list 24 in the memory 26 for a subsequent replay. It should be understood that although information relating to a channel list is illustrated as an example in FIG. 2, any other program can be arranged in various formats.

In the embodiment, when an automatic channel installation is performed, only the general list 23 is updated to include all available programs present to the system 10 from multiple sources. However, according to the teachings of the present invention, the favorite list 24 is unchanged during this process. In addition, using an interface screen as shown in FIG. 3, the user is further able to customize the list of channels or programs contained in the favorite list 24 as they wish. The addition or deletion of a new channel or program can be performed through the action of the input interface (not shown), such as a remote control unit or other means known in the art. Using the input interface, the viewers can specify the type of program or channel they desire to be included or removed in the favorite list 24. For example, as shown in FIG. 3, a user may select to include the MTV channel to the favorite list 24 using the input control of the system 10 for a subsequent viewing. The channel 14 is then deleted after being transferred to the favorite list 24. When another installation of programs or channels occurs, the latest favorite list 24 containing the MTV channel is still unchanged. As a result, the previous favorite program list is not deleted during the automatic channel installation process.

Referring to FIG. 4, the system 10 as depicted in FIG. 1 can be implemented as follows. First, in step 100, the system 10 scans all incoming programs in order to generate a program list 23 as shown in FIG. 2. Here, the system 100 may search the EPG information to find out the broadcast programs and may search the Internet for the information sources. Thereafter, in step 200, the system retrieves programs of interest to the user based on the viewing habit over time to generate the favorite list 24 shown in FIG. 2. The retrieved favorite list 24 is stored in a memory. In step 300, it is determined whether the user requests the update of the favorite list 24 during a viewing mode. If the update request is not made, the viewer has an option of viewing either the general list 23 or the favorite list 24 when making a selection to watch a particular program or show. If the update request is made, the interface screen shown in FIG. 3 is displayed so that the user can selectively transfer programs or channels to the favorite list 24 in step 400. In step 400, the newly updated favorite list 24 is displayed to the user to select the desired program or channel. As a result, the viewer has an option of picking desired programs watched most frequently including the web content of interest, and this list is not lost when performing an automatic channel installation thereafter.

While the preferred embodiments of the present invention have been illustrated and described, it will be understood by those skilled in the art that various changes and modifications may be made, and equivalents may be substituted for elements thereof without departing from the true scope of the present invention. For example, the teachings of the present invention may be applicable to a satellite receiver, DVD/Video recorder or any other device that has a tuner and channel list and configured to perform an automatic channel installation. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

What is claimed is:

1. A method for providing a channel list from a plurality of sources, the method comprising the steps of:
receiving at least one television content (12) and at least one Internet content (14);
identifying a particular program channel liked by a viewer according to a past viewing history (22); and
saving a favorite list (24) containing a list of program channels liked by the viewer based on the past viewing history (22) so that the favorite list (24) is not deleted during an automatic channel installation.

2. The method of claim 1, further comprising the step of displaying the favorite list (24) to the viewer for selection.

3. The method of claim 1, further comprising the step of selectively adding or deleting a program channel to and from the favorite list (24).

4. The method of claim 1, further comprising the step of generating a general list (23) including the at least one television channel and the at least one Internet address, the general list (23) being selectable by the viewer.

5. The method of claim 1, wherein said television content is selectively identified according to an electronic program guide (EPG).

6. The method of claim 1, wherein the plurality of sources includes at least one television network, Internet network, wireless network, and wired network, or a combination thereof.

7. A method for providing a channel list from a plurality of sources, the method comprising the steps of:
generating a general list (23) including at least one television content (12) and at least one Internet content (14) and a favorite list (24) including a particular program channel liked by a viewer according to a past viewing history (22), the general and favorite lists (23, 24) being selectable by the viewer; and
storing the favorite list (24) to prevent deletion during an automatic channel installation.

8. The method of claim 7, further comprising the step of adding and deleting a program channel to the favorite list (24) interactively in response to the viewer's input.

9. The method of claim 7, wherein said television content is selectively identified according to an electronic program guide (EPG).

10. The method of claim 7, wherein the plurality of sources includes at least one television network, Internet network, wireless network, and wired network, or a combination thereof.

11. The method of claim 7, further comprising the step of saving a particular program liked by the viewer according to the past viewing history (22) for a subsequent replay.

12. An apparatus for providing a channel list from a plurality of sources, comprising:
a playback unit(18) for receiving at least one television content (12) and at least one Internet content (14) and generating a favorite list (24) containing a list of program channels liked by a viewer based on a past viewing history (22); and
a display unit(20) for displaying the general list (23) and favorite list (24) so that the viewer can interactively make a selection.

13. The apparatus of claim 12, further comprising an input device adapted to communicate with the apparatus to update the favorite list (24).

14. The apparatus of claim 12, further comprising a memory (26) for storing the general list (23) and the favorite list(24).

15. The apparatus of claim 12, wherein the playback unit (18) further generates a general list(23) including the at least one television content (12) and the at least one Internet content (14).

16. A system for providing a channel list from a plurality of sources, comprising:
a memory (26) for storing a computer-readable code; and,
a processor (18) operatively coupled to said memory (26), said processor (18) configured to:
generate a favorite list (24) including a particular program channel liked by a viewer according to a past viewing history(22), the favorite list (24) being selectable by the viewer; and
store the favorite list (24) to prevent deletion during an automatic channel installation.

17. The system of claim 16, wherein the processor (18) is further configured to update the favorite list (24) by adding or deleting a particular program channel from the favorite list (24).

18. The system of claim 16, wherein the processor (18) is further configured to display the favorite list to the viewer for selection.

19. The system of claim 16, wherein the processor (18) is further configured to generate a general list (23) including at least one television content (12) and at least one Internet content (14), the general list (23) being selectable by the viewer.
